(19) United States
(12) Patent Application Publication
(10) Pub. No.: US 2014/0220519 A1
(43) Pub. Date: Aug. 7, 2014

(54) ALPHABET TEACHING AID

(71) Applicant: ALICIA SILVER, Haddon Heights, NJ (US)

(72) Inventor: ALICIA SILVER, Haddon Heights, NJ (US)

(21) Appl. No.: 13/761,151

(22) Filed: Feb. 6, 2013

(51) Int. Cl. G09B 17/04

(52) U.S. Cl. CPC G09B 17/04
USPC 434/178

(57) ABSTRACT

A teaching aid for children learning the alphabet of any language utilizing a combination of alpha characters each in a cluster with a word starting with the alpha character and a drawing that are drawn in a child's hand. A preferred configuration is an alphabet strip with irregular child drawn borders appearing on a substrate. The substrate may be a clear plastic of any outline but with the border and background as well as the clusters mechanically or electronically printed.

### CROSS-REFERENCE TO RELATED APPLICATIONS

This US Non-Provisional Utility Patent application claims priority from U.S. Provisional Patent Number 61/595,583, with Inventor Alicia Silver filed on Feb. 6, 2012.

This US Non-Provisional Utility Patent application claims priority from US Provisional Patent Number 61/684,728, with Inventor Alicia Silver filed on Aug. 18, 2012.

### STATEMENT REGARDING FEDERALLY SPONSORED RESEARCH OR DEVELOPMENT.

Not Applicable

### THE NAMES OF THE PARTIES TO A JOINT RESEARCH AGREEMENT.

Not Applicable

### INCORPORATION-BY-REFERENCE OF MATERIAL SUBMITTED ON A COMPACT DISC.

Not Applicable

### BACKGROUND

Research has shown that a child will transition readily into the first grade if they can recite and identify all of the letters of the alphabet and associate each letter with the name of a familiar object. Currently available alphabet teaching aids are cute and decorative so the parents will buy them. The current designs give little regard to supporting an organized, class room proven, methodology evoking the intellectual impressions for learning that will get them into the first grade.

### SUMMARY OF THE PRESENT INVENTION

The preferred embodiment of the present invention overcomes the short comings of other alphabet teaching aids by application of the following core principles:
Index the printed material with an alpha indicia to evoke the intellectual impression of teaching one alpha at a time;
Providing a child's hand drawn graphic indicia to evoke an intellectual impression establishing a comfort level with the student;
Placing the hand drawn graphic indicia in the proximity of the indexed alpha indicia to evoke the intellectual impression of association between the alpha indicia and the graphic indicia;
Printing a combination of alphas in a child's hand in a third indicia to evoke an intellectual impression reinforcing the comfort level with the student and associating the combination of alpha indicias with the graphic indicia;
Mechanically reproducing another form of the alpha indicia near the child's hand drawn indicia.
Optionally, Mechanically reproduce an indicia of child's hand lettering to evoke an intellectual impression connecting pronunciation to the graphic indicia
an equivalent but different alpha indicia near the indexed alpha indicia to evoke the intellectual impression of differing forms of the alpha indicia; Print any additional graphic indicia, decorative indicia or embellishment indicia away from any of the five aforementioned indicia to prevent student distractions or confusion.
Cutting of the periphery of the printed matter in an irregular child's cut outline to further evoke the intellectual impression of child comfort. The teaching aid of claim 6, wherein:
The first element is drawn as an outline for the child to color.
One or more first elements are of people, possessions or places familiar to the specific child being taught the alphabet.
The teaching aid is mechanically or electronically reproduced on a colored background that is also mechanically or electronically reproduced and bounded by the outline on a clear or translucent substrate.
Using the singing of a song to

Additional optional features of the preferred embodiment are:
Adding an alpha indicia that evokes the intellectual impression of syllables;
Adding an alpha indicia that evokes the intellectual impression of pronunciation;
Adding mechanically reproduced child-like printed indicia to evoke the intellectual impression of further uses of the alpha indicia;
Adding an product name indicia that evokes the intellectual impression of child ownership;
Further evoke the intellectual impression of child ownership by adding a black outlined graphic indicia for the student to color;
And still further evoke the intellectual impression of child ownership by adding custom graphic indicia of the child's family, pets or family members;

### BRIEF DESCRIPTION OF THE SEVERAL VIEWS OF THE DRAWING(S).

FIG. 1: is a plan view of the preferred configuration of the present invention,

FIGS. 2, 3 and 4: are plan views of the preferred embodiment showing key characteristics,

FIG. 5: is a key to the drawing reference codes identifying characteristics of the preferred embodiment of the present invention,

FIGS. 6 to 9: show a second embodiment of the present invention,

FIG. 10: Is a block diagram showing the method of using the second embodiment of the present invention.

### DETAILED DESCRIPTION OF THE PREFERRED EMBODIMENT OF THE PRESENT INVENTION.

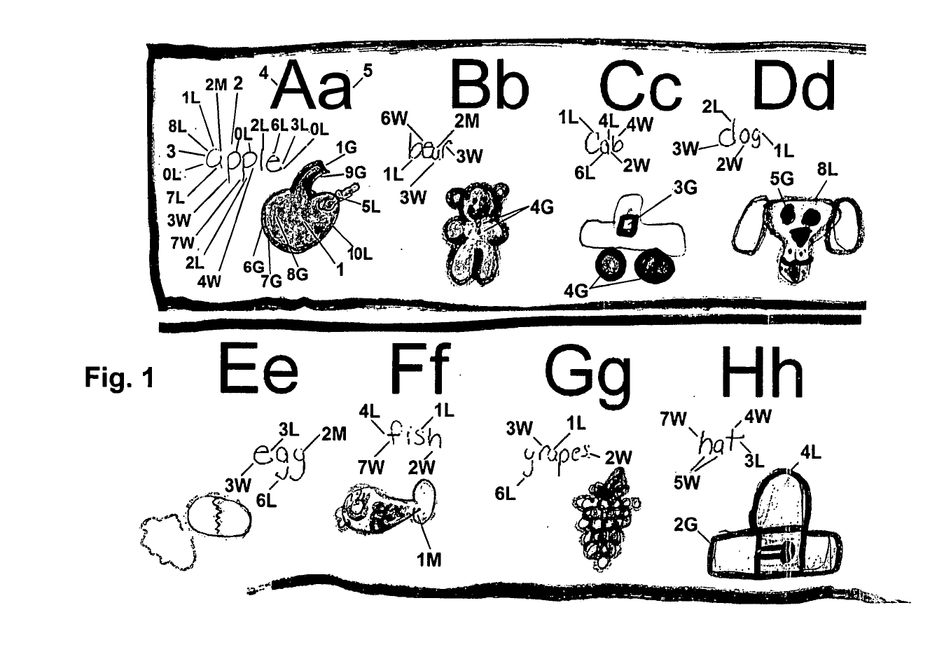

FIG. 1 shows the preferred configuration of the present invention as an alphabet teaching aid with a child drawn outline and child cut periphery for demonstrating the alphabet with a child printed word starting with each letter and a corresponding child made drawing illustrating each word.

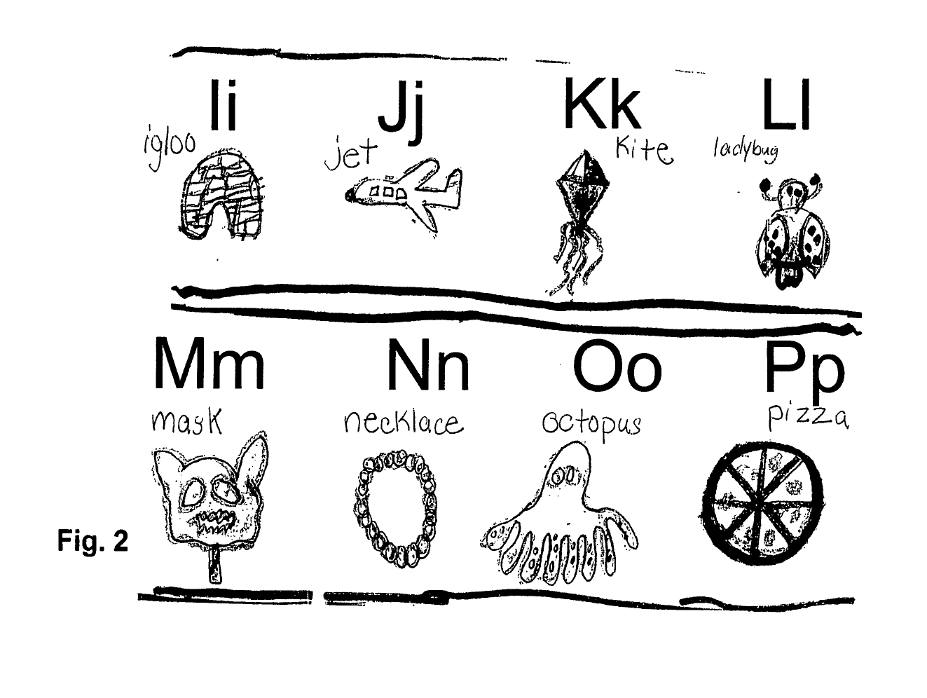

FIG. 2 shows the character and graphic grouping of the preferred embodiment of the present invention as it can be applied to any of a number of products and media to aid in teaching the alphabet. The subject of the hand drawn object 1 in the present invention can be chosen from objects familiar to societies living on any part of the planet or within the grasp of students from any socio-economic status within a society. The hand drawn word 2 can be from any type of writing whether character, glyph, pictogram or any other language base, so long as it describes the hand drawn object 1. The featured part of the word 3, which in the preferred embodiment is the first letter, can alternatively be a syllable, sound or some component of the word that is distinguishable in a mechanically reproduced form which in the preferred embodiment is a capitol letter 4 and lower case letter 5 in a popular san-serif typeface. The graphic components of the preferred embodiment can be arranged in any position relative to each other however, for maximum teaching impact the eye of the student should start at the hand drawn object, progress to the hand drawn word and end at the mechanically reproduced letters 3 and 4. Furthermore, the preferred embodiment can be applied to the gamut of printed products including but not limited to alphabet strips, cards, posters, books and magazines. Electronic media is also well suited to bringing the preferred embodiment of the present invention to the student such as but not limited to the Internet, television, films, videos and facsimile. The delivery of Internet and electronic media to the student could be but not limited to hand held cell phones, smart-phones, electronic tablets, portable computers. Also, the graphic elements of the present invention may be presented in three-dimension or with motion. Picture for a moment a student watching a three dimensional image of the apple 1 that enlarges and rotates to draw the students attention followed by the apple shrinking and the word apple 2 scrolling across the screen as it gets larger and is accompanied by a verbalization of the word. Then the word apple 2 shrinks except for the letter “a” 3 that appears for a moment and then alternately flashes on the screen accompanied by vocalization of the “a” sound. Finally attention is drawn to the mechanically reproduced letters that arrive whirling in a tornado with the capitol letter 4 being verbalized by a low pitched voice and the loser case letter being vocalized by a high pitched voice. This dramatization meets the requirements of the present invention by presenting the apple 1 which is familiar to the student first, then drawing attention to the hand written word apple 2, followed by attention to the first letter in apple “a” 3 followed by the mechanically reproduced letters. The order in which any of the graphics herein described may be changed so long as they appear in essentially a line or a cluster in proximity to the other graphics associated with the same letter of the alphabet.

The sixth core element of the present invention is that of space. Space is represented by the box 6 surrounding the other five core elements. The square is clear of any other graphic that could distract the student from focus on learning the letters of the alphabet or even worse from believing that the letter being learned always includes the other graphic. The core element of space being missing is a major cause of the poor teaching results achieved using commercially available alphabet teaching aids available today.

Lastly, the present invention can be practiced in the teaching environments of the future because the preferred embodiment of the present invention can be applied to interactive learning using any of the aforementioned devices or media, for instance the student can be supplied with an outline of the hand drawn apple 1 for the student to color in any media, lines can be supplied across the virtual or physical media on which to hand draw the word 2 and its first hand drawn character 3 and a key board, rubber stamp, tracing template or other means of producing the mechanically reproduced characters 4 and 5. Further, student generated images can be transferred from physical to virtual media using a cell phone camera and visa versa by an electronic printer but not limited to these devices.

What ever the device or the media one can quickly determine if the preferred embodiment of the present invention is being practiced by answering yes to the following questions:
Is the object familiar to a student from their experience?
Is the drawing technique of the object within the ability off a 4-6 year old?
Is the word the common name of the object?
Is the lettering technique of the word within the ability off a 4-6 year old?
Is the first letter of the word also presented as the upper and or lower case mechanically reproduced letter?
Are all of the graphics associated with the same letter of the alphabet in essentially a line or a cluster.
Optionally is the name of the object mechanically reproduced with syllable and pronunciation markings?
Is there clear space around the object, word and mechanically reproduced letters to prevent distractions or confusion?

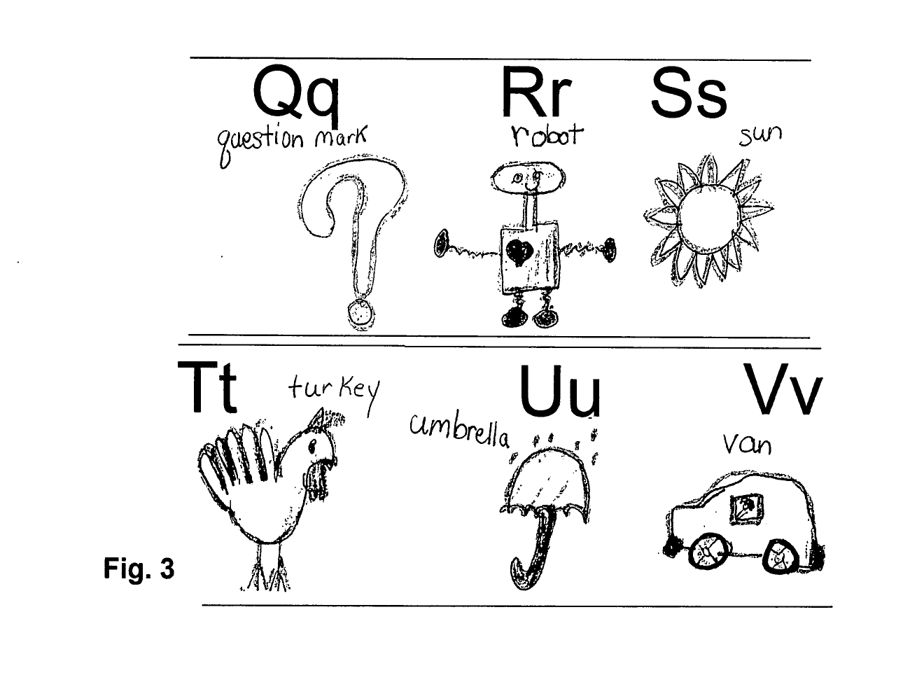

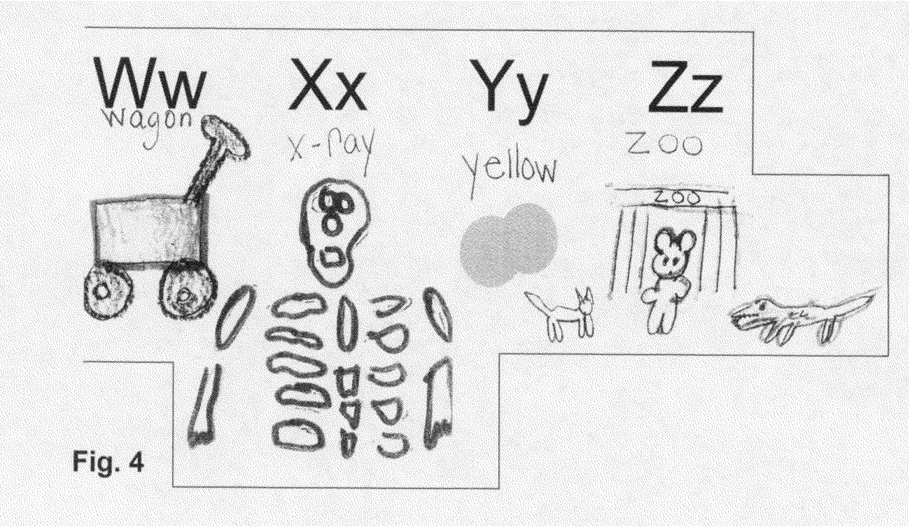

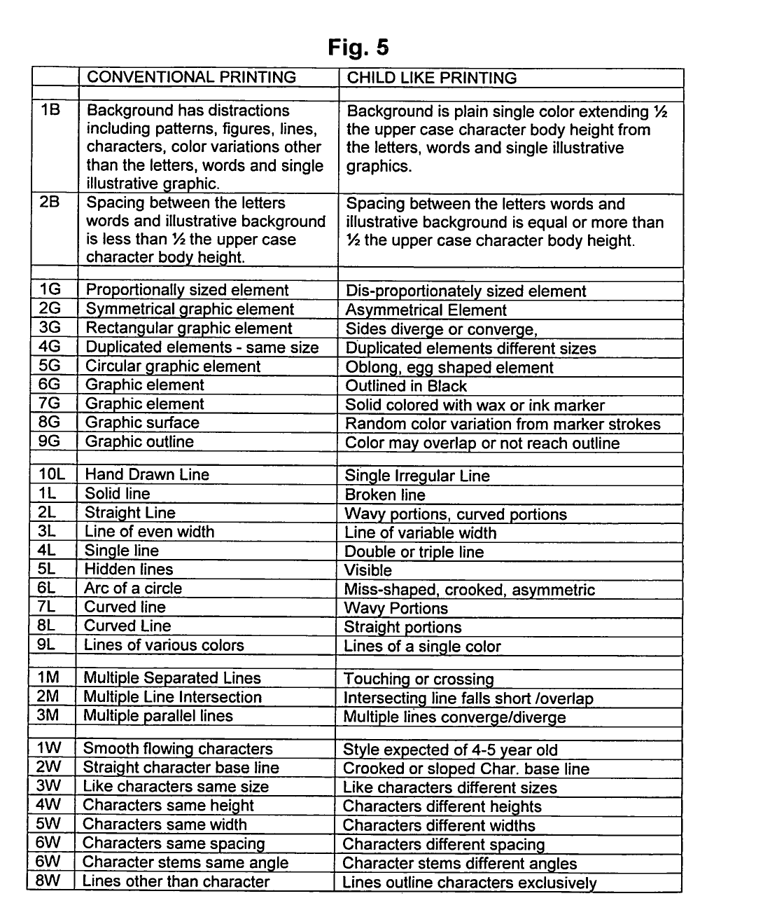

Should the answer to the questions concerning the lettering ability of a 4-6 year old be in question, FIGS. 3, 4 and 5 are presented for border line cases where skill level is not easily determined. The drawing reference numbers in FIGS. 3 and 5 correspond to the drawing reference numbers in the left hand column of FIG. 4. The middle column describes the drawing characteristic that a trained adult would apply to draw the object or letter the characters. The right hand column describes the drawing and lettering characteristic that can be expected when done by a 4-6 year old. If one goes over several characters or objects and marks each of the characteristics in the middle column and each of the characteristics that are in the right hand column and the majority of the characteristics are in the right hand column the drawing is considered to be at the highest level achievable by a 4-6 year old. The average 4-6 year old will be hard pressed to achieve more than a few characteristics in the middle column with their lettering and drawing skill level.

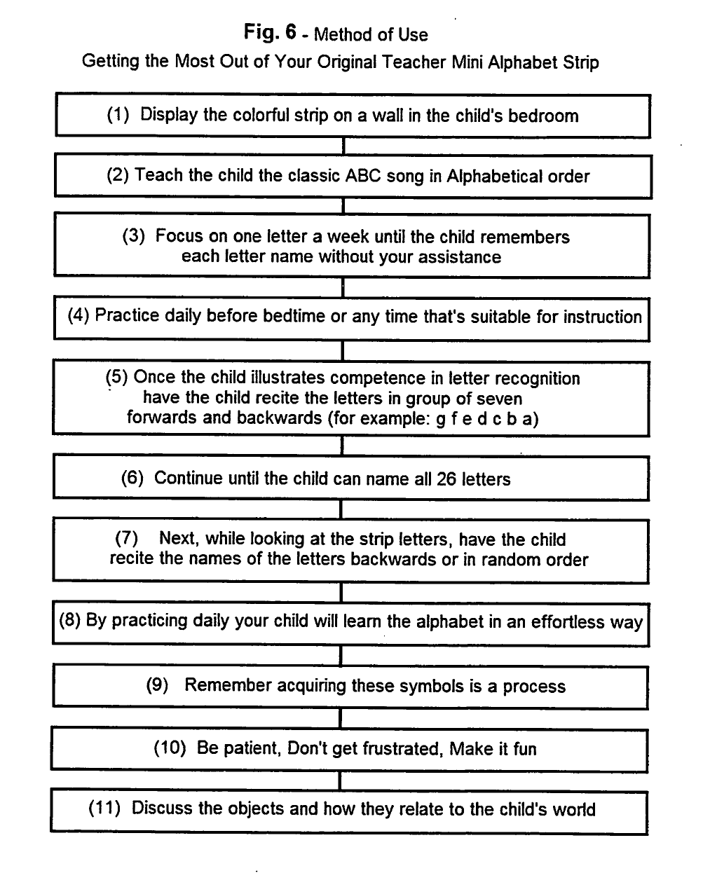

FIGS. 6-9 show a second embodiment of the present invention which is a printed strip containing 26 of the preferred embodiments of the present invention that are located side by side and the letters are in alphabetical order. However, the location of the preferred embodiments of the present invention may be any orientation and the strip may take any shape. The strip of the second embodiment of the present invention adds a hand drawn border 7 to further evoke the intellectual impression of comfort to a child with a child drawn, child friendly and comfortable teaching aid. To further this theme the outline of the strip is irregular and has vertically protruding areas 8 along the long horizontal edge and horizontal protruding areas 9 along the shorter vertical edge. Although the alphabet strip is often implemented in strip form the second embodiment of the present invention can also be applied on children's furniture, blackboard and picture frames, decorative wall trim Etc as well as used either as the focus of virtual media or a supplemental rolling banner across the bottom of the screen during children's interaction with virtual media. Even smell-a-vision is on the drawing boards so the student's interaction could include olfactory feed back while learning the alphabet.

FIG. 10 is a block diagram of the recommended method of use of the second embodiment of the present invention. The steps are self explanatory and can be added to abbreviated or placed in different order depending on the learning environment, teacher preferences or student considerations.

I claim:

1. A teaching aid comprising:
a cluster of three or more elements appearing on a substrate;
a first element consisting of: a first drawing of a first object that is common to a child learning an alphabet;
a second element consisting of: a printed first name of the first object:
wherein the first drawing and the printed name of the first object contain at least one of the following attributes that are common in child handmade drawings and child hand printed letters: symmetrical element sides diverge or converge or are different sizes, oblong or egg shaped element that is normally circular, solid colored area outlined in a darker color, solid areas colored with wax or ink marker, random color variation in solid colored areas from liquid or wax marker strokes, color may overlap or not reach outline, single irregular line, broken line, wavy or curved lines that are meant to be straight, single lines having variable width or drawn as double or triple line, miss-shaped, crooked, or asymmetric characters, intersecting lines falls short or overlap each other, multiple lines randomly converge or diverge, crooked or sloped character base line, like characters printed in different widths or different heights, character spacing is out of proportion to character widths, stems of the same character are printed at different angles.
a third element consisting of: at least one case of a mechanically reproduced printed character of an alphabet.

2. The teaching aid of claim 1, wherein:
two or more of the clusters each having at least one element of differing content from all of the other clusters appear on the substrate.

3. The teaching Aid of claim 2, wherein:
the two or more clusters are surrounded on at least two sides by an outline that exhibits at least one of the attributes.

4. The teaching Aid of claim 3, wherein:
the clusters are arranged where the mechanically reproduced printed characters of an alphabet are in alphabetical order.

5. The teaching Aid of claim 4, wherein:
the two or more clusters are arranged side by side in an essentially horizontal line.

6. The teaching aid of claim 5, wherein:
one or more of the printed names with one or more of: syllable markings, pronunciation markings.

7. The teaching aid of claim 6, wherein:
the first element is drawn as an outline for the child to color.

8. The teaching aid of claim 7, wherein:
one or more first elements are of people, posessions or places familiar to the specific child being taught the alphabet.

9. The teaching aid of claim 8, wherein:
the teaching aid is mechanically or electronically reproduced on a colored background that is also mechanically or electronically reproduced and bounded by the outline on a clear or translucent substrate.

10. A method of use of a teaching aid:
supplying a teaching aid of the present invention;
mounting the teaching aid on a surface;
singing the classic ABC song with the child while drawing attention to a cluster of the teaching aid being recited in the song.
